(19) United States
(12) Patent Application Publication
(10) Pub. No.: US 2008/0149797 A1
(43) Pub. Date: Jun. 26, 2008

(54) Protective sleeve

(75) Inventors: Shih-Sheng Yang, Taipei Hsien (TW); Aly Khalifa, Raleigh, NC (US)

Correspondence Address: Universal Trim Supply Co., Ltd., P.O. Box No. 6-57, Junghe, Taipei, 235, omitted

(73) Assignee: Universal Trim Supply Co., Ltd.

(21) Appl. No.: 11/643,843

(22) Filed: Dec. 22, 2006

(51) Int. Cl. G10G 5/00

(52) U.S. Cl. 248/311.2

(57) ABSTRACT

A protective sleeve includes primarily a sleeve which contains an emplacement space for installing an MP3 (digital audio player) and is formed integrally. A back plate at an opening end at a top of the sleeve is extended upward to form an extension piece which is provided with a through-hole, and an enhancement rib is located at a bottom side of the extension piece and is extended downward to a position below the sleeve. A slot hole is located at a bottom surface of the sleeve, a transparent and concaved window area is located at a top plate of the sleeve, and a hollow part is located at a bottom of the window area. Accordingly, the sleeve can achieve a function of protection, and is provided with effects of a stronger structure and better practicability.

### BACKGROUND OF THE INVENTION

(a) Field of the Invention

The present invention relates to a protective sleeve, and more particularly to a protective sleeve which provides an effect of protection, facilitates a user to operate function buttons, and can be hung on the user's neck with a rope, for an MP3 (digital audio player), thereby achieving the best practicability in usage.

(b) Description of the Prior Art

As improvement of technology and movement of era, a conventional CD (Compact Disc) player which has a large size has been replaced by an MP3 (digital audio player) walkman which is small in size and has a large memory. For example, an ipod (ipod is an MP3 digital audio player and is a dedicated trademark of SONY) which was designed and manufactured by SONY, has resulted in a wave of fashion when it is built and sold worldwide. It can be seen everywhere no matter when sitting at home, traveling or doing outdoor activities. As the ipod has a beautiful shape and a small volume, and is easy to carry, an ordinary user is accustomed to hang it on a chest, which can facilitate an operation and achieve a function of decoration. However, as the machine is exposed out, it is easy to be scratched or even damaged due to a collision. Therefore, a kind of protective sleeve for emplacing the MP3 and serving as a protection has been arisen.

Nevertheless, there are so many kinds and styles of the protective sleeves sold in the market. Accordingly, how to develop a new kind of MP3 protective sleeve having a stronger structure and better practicability for meeting an expectation of consumers is an object of breakthrough endeavored by related industries.

### SUMMARY OF THE INVENTION

The primary object of present invention is to provide a protective sleeve which can achieve a function of protection, and is also provided with a stronger structure and can be more convenient to operate.

Another object of the present invention is to provide a protective sleeve which can be put upright or hung at an air exit of air conditioner in a car, depending on a variety of usage requirement, so as to achieve a plurality of various hanging and holding effects.

Still another object of the present invention is to provide a protective sleeve which can be fitted with a hanging device to be hung in front of a chest by directly transfixing a rope on a locking piece of the hanging device, such that when a user is carrying out an outdoor activity such as dancing, which is provided with large momentum, the protective sleeve with this hanging method can effectively maintain a function of operating press buttons extremely easily.

Accordingly, the present invention is primarily composed of a sleeve having an emplacement space for installing an MP3. A back plate at an opening end at a top of the sleeve is extended upward to form an extension piece having a through-hole for suspending a hanging device. An enhancement rib is located at a bottom side of the extension piece and is extended downward to a position below the sleeve to enhance the structure of sleeve and to reduce contact area of the sleeve with a user's body, thereby achieving better ventilation and sense of comfort. A slot hole is located at a bottom surface of the sleeve, such that an expansion slot at a bottom of MP3 can be directly connected to an external earphone device without taking out the MP3. A transparent and concaved window area is concaved at a top plate of sleeve, corresponding to a position of screen panel of the MP3, to facilitate the user to directly touch a press button panel of the MP3. On the other hand, two sides of a bottom plate of hollow part are provided with arc-shape slots to facilitate the user to grab and take out the MP3 easily, thereby enabling the sleeve to be provided with a function of protection, a stronger structure and better practicability. Furthermore, as the present invention is fitted with a rope and a locking piece for hanging, it can be carried outdoors conveniently, and every press buttons on the MP3 machine can be operated extremely easily when the user is listening to music and dancing at a same time.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows a rear perspective view of the present invention.

FIG. 3 shows a transversal cutaway view of the present invention.

FIG. 4 shows a schematic view of the present invention being combined with an MP3 (digital audio player).

FIG. 5 shows a longitudinal cutaway view of the present invention being combined with an MP3.

FIG. 6 shows a schematic view of another embodiment of the present invention being locked, which is different from that in FIG. 4.

FIG. 7 shows a schematic view of a locking example as in FIG. 6.

FIG. 8 shows a perspective view of an earphone wire reel, which is an accessory of the present invention.

FIG. 9 shows a side cutaway view of an earphone wire reel, which is an accessory of the present invention.

FIG. 10 shows a schematic view of a protective sleeve of the present invention being assembled with an earphone wire reel.

FIG. 11 shows a local cutaway view of a protective sleeve of the present invention being assembled with an earphone wire reel.

FIG. 12 shows a schematic view of the present invention using an earphone wire reel to reeve an earphone wire.

FIG. 13 shows a schematic view of an assembly of a protective sleeve of the present invention with an MP3, which is put upright on a desktop.

FIG. 14 shows a schematic view of an assembly of a protective sleeve of the present invention with a hook, which is hung at an air exit of air conditioner.

FIG. 14A shows a partial enlarged view of a hook head-end in FIG. 14.

### DETAILED DESCRIPTION OF THE PREFERRED EMBODIMENTS

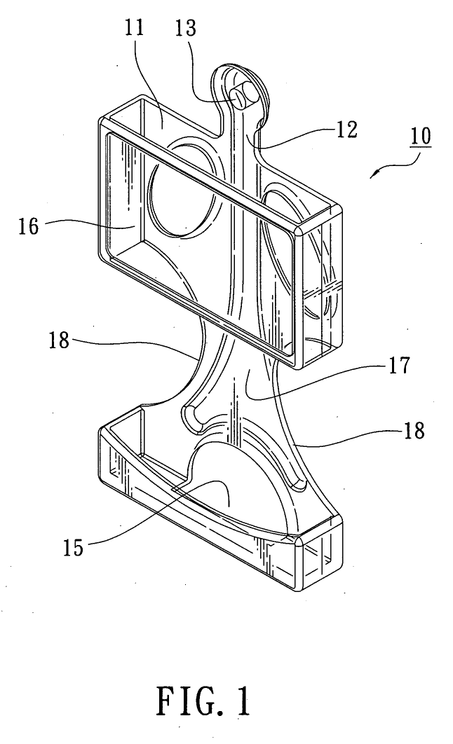

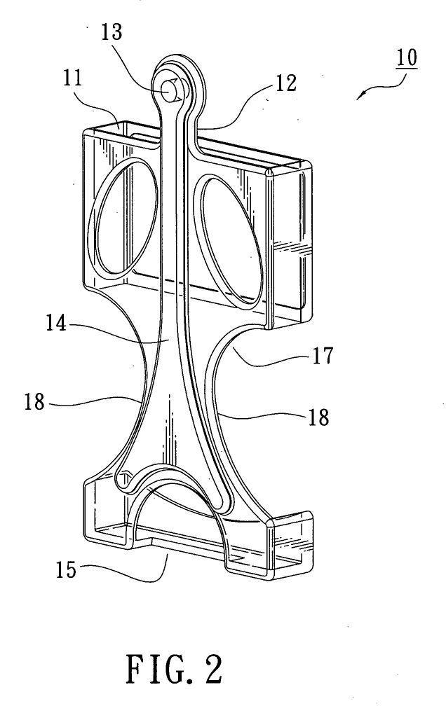

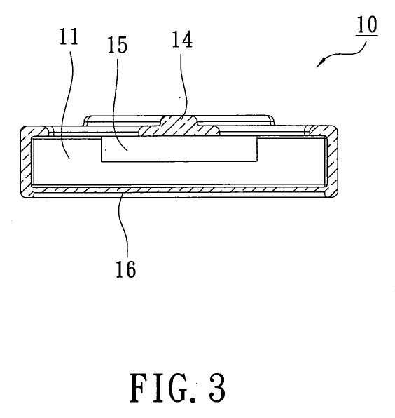

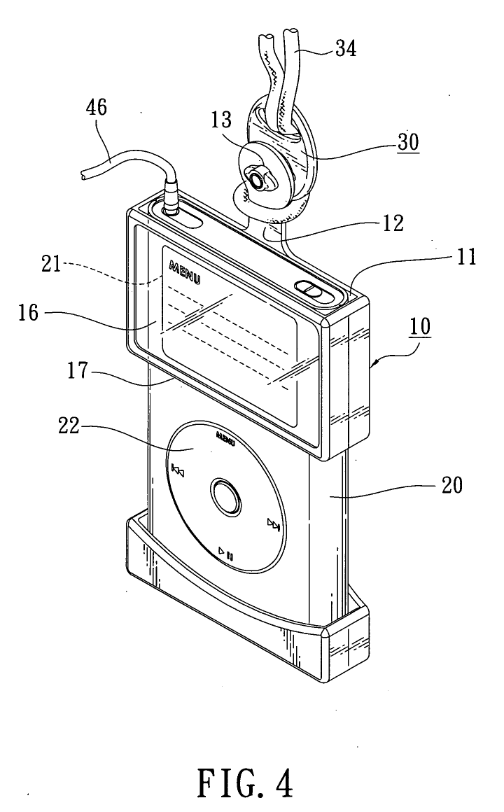

Referring to FIGS. 1 to 4, the present invention provides a protective sleeve which is formed integrally from a soft plastic material. The material can be made by polyurethane, is flexible, and can be added with color fixatives to manifest the color. The sleeve 10 is provided with an emplacement space 11 for installing an MP3 (digital audio player) 20 (as shown in FIG. 4). An opening end 11 is located above the sleeve 10, and a back plate is extended upward to form an extension piece 12 which is provided with a through-hole 13; whereas an enhancement rib 14, which is extended to a position below the sleeve 10 from top to bottom, is located at a bottom side of the extension piece 12. In addition, a slot hole 15 is located at a bottom surface of the sleeve 10, a transparent and concaved window area 16 is located at a top plate of sleeve 10, corresponding to a position of screen panel 21 (as shown in FIG. 4) of the MP3 20, and a hollow part 17 is located at a bottom of the window area 16, with arc-shape slots 18 being located at two sides of a bottom plate of the hollow part 17. The aforementioned window area 16 is a membrane made by polyurethane, and is a thin layer of highly transparent and clear material, which is emplaced in a machining mold (not shown in the drawings), such that when a main body of the sleeve 10 is formed by a plastic-extrusion procedure, the sleeve material can be assembled integrally with the membrane.

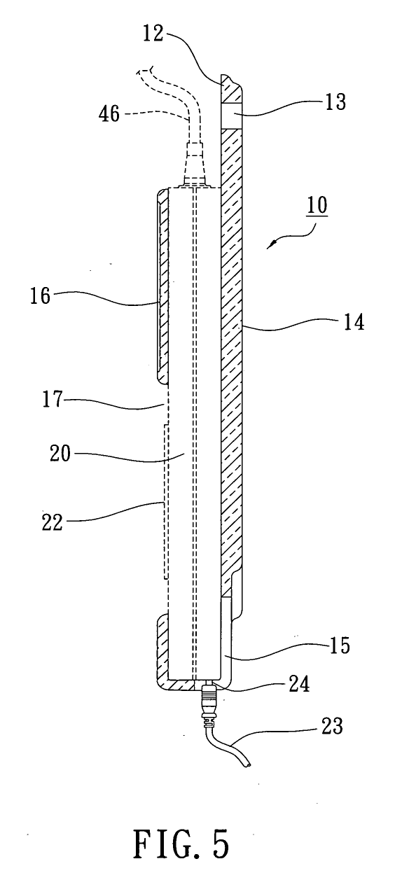

Referring to FIG. 4 and FIG. 5, the MP3 20 is inserted into the emplacement space 11 of sleeve 10, and a press button panel 22 of the MP3 20 is exposed at the hollow part 17 of sleeve 10, so as to facilitate a user to operate and press the press button panel 22 on a front of the MP3 20 without pulling the MP3 20 out of the sleeve 10, and to enable the user to clearly take a look at a message displayed on the screen panel 21 of MP3 20 from the transparent window area 16 at top. As shown in FIG. 4, a hanging device 30 can be connected to the through-hole 13 on the extension piece 12 and can be reeved with a rope 34, such that the MP3 20 can be hung on a neck of the user to achieve effects of carrying personally and serving as a protection. In addition to that by a means of the enhancement rib 14 at the back side of extension piece 12, structural intensity of the sleeve 10 can be reinforced, better air permeability can be provided when the sleeve 10 is attached on a human skin, so as to reduce sweating due to contact between the sleeve 10 and the user's body, thereby achieving better ventilation and sense of comfort. On the other hand, when the user needs to connect to a charger power cord 23 from a power slot 23 (as shown in FIG. 5) at a bottom of the MP3 20, he or she can use the slot hole 15 at the bottom surface of sleeve 10 to connect directly, without taking the MP3 20 out of the sleeve 10. As a top end of the emplacement space 11 is in an open state, another external earphone wire 46 can be directly connected, and If the MP3 20 needs to be taken out of the sleeve 10, the arc-shape slots 18 at two sides of the hollow part 17 can facilitate the user to easily grab and take it out with fingers.

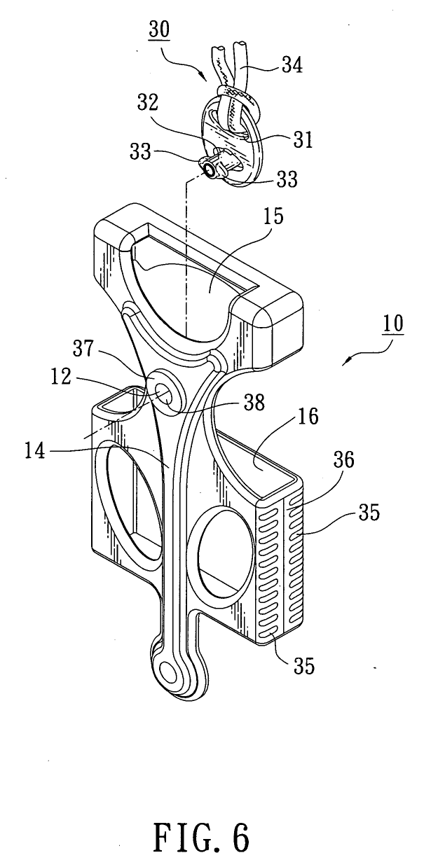

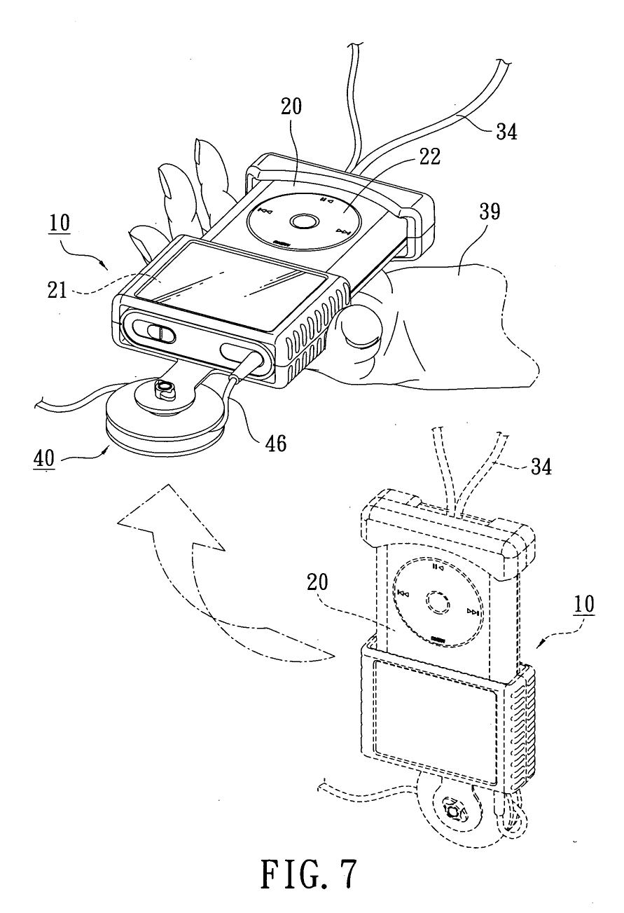

Referring to FIG. 6 and FIG. 7, a plurality of grooves 35 is located at two side plates of the sleeve 10, next to the window area 16, and the plural grooves 35 are aligned and distributed on walls 36, such that thicker parts are located at positions on the side plates of the sleeve 10 without grooves to prevent from being torn apart, and in a mean time, bottoms of the grooves are thinner parts to reduce transversal cross sections for allowing for larger tension. The best thickness of the wall 36 that allows for a change of size of the emplacement space is designed to be 1.0 mm˜2.0 mm. The sleeve 10 can be mutually assembled with the hanging device 30, which is made by a soft plastic material, and a plate of which is provided with a through-hole 31 and a pillar 32. Two side edges at a top end of the pillar 32 are provided with locking ears 33 which are expanded outward. Upon using the present invention, the rope 34 can be first transfixed into the through-hole 31 on the hanging device 30, and a ring 37 is fixed on the enhancement rib 14 of the sleeve 10. As a center of the ring 37 is provided with a through-hole 38, the locking ears 33 can be locked into the through-hole 38, to lock the sleeve 10 on the pillar 32 of the hanging device 10, thereby achieving a quicker and more convenient locking function. The user can then hang the rope 34 on the neck to carry outdoors, which forms a different hanging method from that in FIG. 4. As shown in FIG. 7, when the MP3 is inserted into the sleeve 10, and is held by a palm 39 upon hanging the MP3 upside down, the message texts shown on the screen panel 21 will be exactly facing toward a view angle of the user for facilitating application.

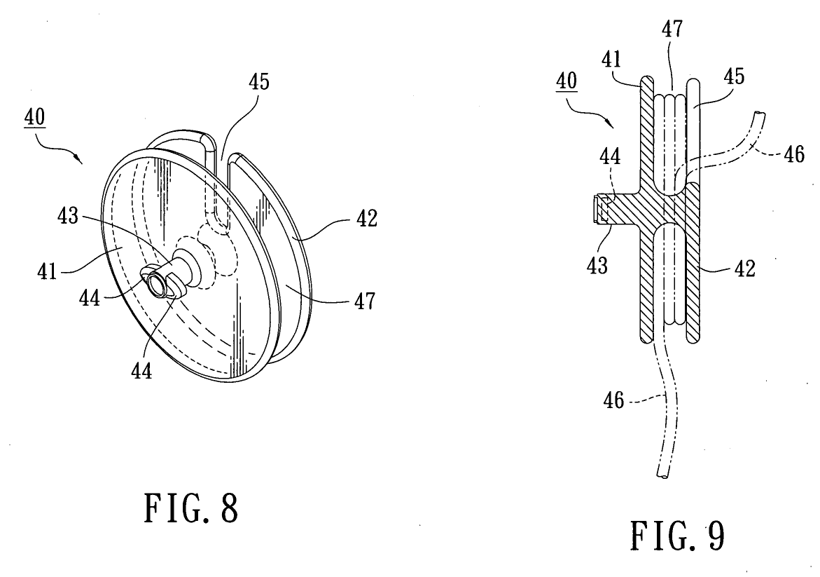

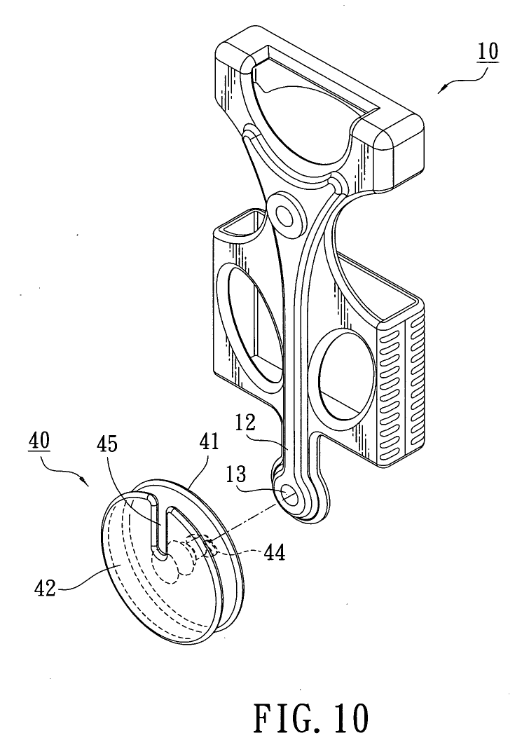

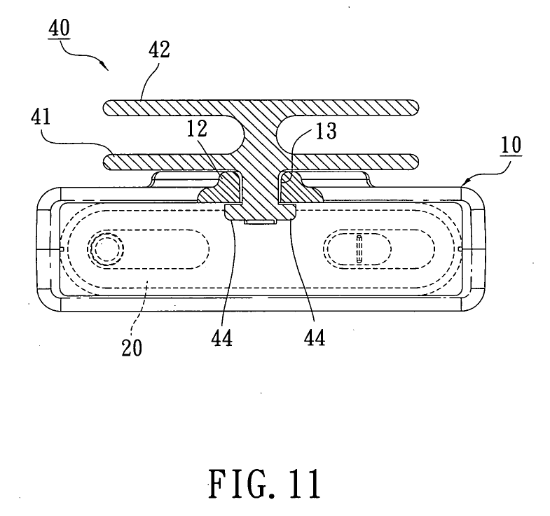

Referring to FIGS. 7 to 11, the present invention can be added with a slip-proof earphone wire clip 40 which includes an upper clip board 41, a lower clip board 42, and a central shaft located between the two clip boards. An end of the shaft is protruded out of the upper clip board 41 to form a short pillar 43, two side edges at a top end of the short pillar 43 are provided with locking ears 44 which are expanded outward, and the lower clip board 42 is provided with a notch 45. Upon using the present embodiment, two locking ears 44 are locked into the through-hole 13 of the sleeve 10 (as shown in FIG. 10 and FIG. 11), and then an earphone wire 46 is continuously reeved on a narrow slot 47 on the shaft between the upper and lower clip boards for collection, such that the more rounds the wire is reeved, the shorter the length of the earphone wire 46 is exposed.

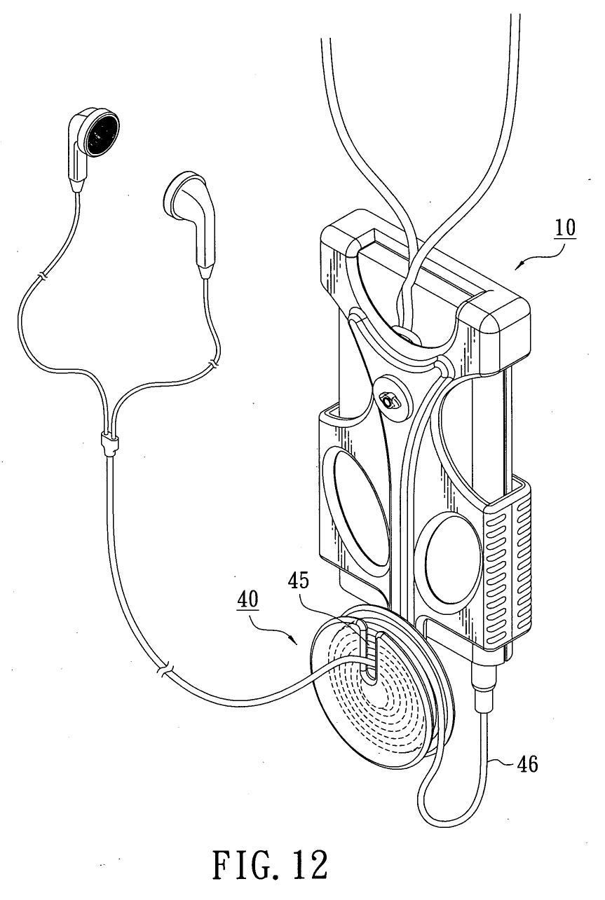

Referring to FIGS. 10 to 12, when the earphone wire clip 40 of the present invention is assembled by locking the two locking ears 44 of the pillar 43 into the through-hole 13 of the extension piece 12 on the sleeve 10, and after the MP3 is emplaced into the sleeve 10, the earphone wire clip 40 can be rotating by a poking of the user's fingers, which can effectively pull out and extend the earphone wire 46 or facilitate reeving back the earphone wire 46 for collection.

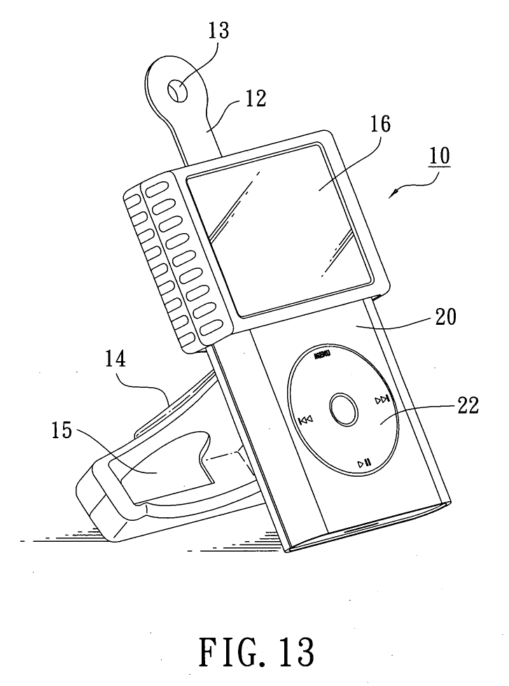

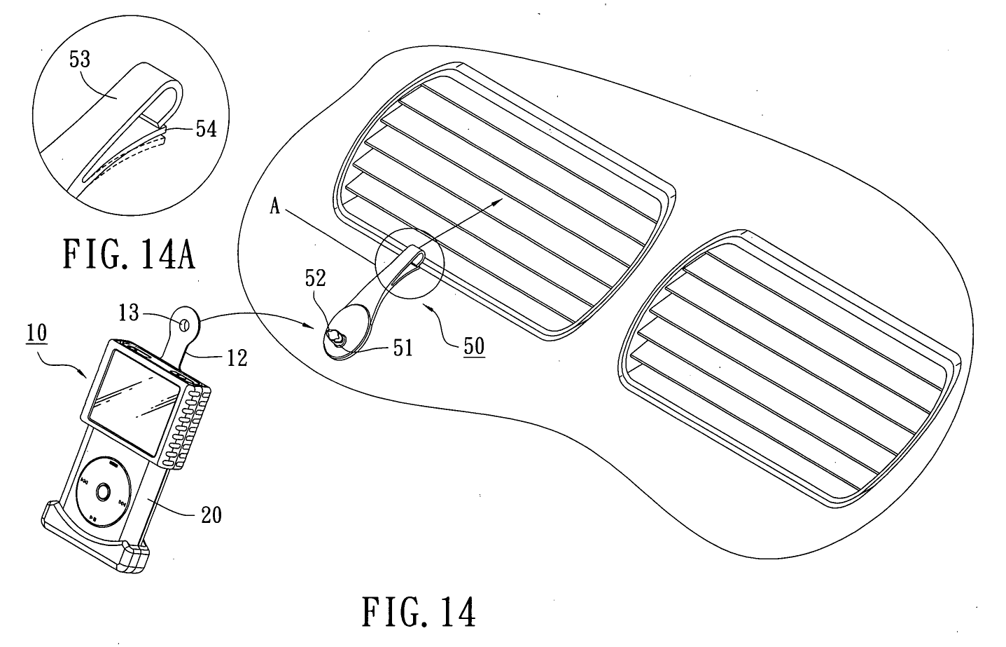

Referring to FIG. 13, after the emplacement space 11 of the sleeve 10 of present invention is inserted with the MP3 20, as the sleeve 10 is made by polyurethane and is hence flexible; the enhancement rib 14 can be bended backward. In addition, by forming a upright foot at a bottom of the MP3 and the sleeve 10, the user can conveniently play music while the MP3 is put on a desktop.

Referring to FIG. 14 and FIG. 14A, the through-hole 13 of the extension piece 12 of the sleeve 10 is assembled with a hook 50, a bottom of the hook 50 is provided with a pillar 51 and a locking ear 52, and an end of the hook 50 is provided with a hook rod 53 and a fastening piece 54; therefore, the MP3 20 can be hung at an air exit 55 of air conditioner in a car by using this accessorial hook 50.

Accordingly, the protective sleeve structure of the present invention is provided with the function of protection and the effects of stronger structure and better practicability with a simple structure, to serve general consumers, thereby having a value of utilization in industries.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A protective sleeve, which is formed integrally from a soft plastic material, comprising an emplacement space for installing an MP3 (digital audio player), wherein a back plate at an opening end at a top of the sleeve is extended upward to form an extension piece having a through-hole; a slot hole is located at a bottom surface, a transparent and concaved window area is located at a top plate of the sleeve, corresponding to a position of screen panel of the MP3; and a hollow part is located at a bottom of the window area.

2. The protective sleeve according to claim 1, wherein the sleeve is made by a flexible material, polyurethane, which is added with color fixatives to manifest the color.

3. The protective sleeve according to claim 1, wherein the window area is provided with a membrane which is a thin layer of highly transparent and clear material made by polyurethane, and is emplaced in a machining mold, such that when a main body of the sleeve is made by a plastic-extrusion procedure, the sleeve material is integrally assembled with the membrane.

4. The protective sleeve according to claim 1, wherein a bottom side of the extension piece is provided with an enhancement rib which is extended to a position below the sleeve from top to bottom, and is extended backward, such that the sleeve is kept putting upright on a desktop.

5. The protective sleeve according to claim 1, wherein two sides of a bottom plate of the hollow part are provided with penetrating arc-shape slots.

6. The protective sleeve according to claim 1, wherein a plurality of grooves is located at two side walls of the sleeve, next to the window area, with thinner parts of the grooves being provided with a reduced transversal cross section to allow for larger tension, and with the perfect design thickness of the wall being 1.0 mm˜2.0 mm.

7. The protective sleeve according to claim 1, wherein the enhancement rib of the sleeve is provided with a ring, and a center of which is provided with a through-hole, enabling a hanging device to be locked into the through-hole of the ring; the hanging device being made by a soft plastic material, a plate of which being provided with a through-hole and a pillar, and two side edges at a top end of the pillar being provided with locking ears which are expanded outward; a rope being transfixed into the through-hole of the hanging device for achieving a quicker and more convenient locking function, and by hanging on a user's neck with a rope, the MP3 being carried outdoors.

8. The protective sleeve according to claim 1, wherein a slip-proof earphone wire clip is further provided, including an upper clip board, a lower clip board, and a central shaft located between the upper and lower clip boards; an end of the shaft being protruded out of the upper clip board to form a short pillar, two side edges at a top end of the pillar being provided with locking ears which are expanded outward, and the lower clip board being provided with a notch.

9. The protective sleep according to claim 1, wherein a hook is further provided, a bottom of which is provided with a pillar and a locking ear, and an end of which is provided with a hook rod and a fastening piece.
